(19) United States
(12) Patent Application Publication
(10) Pub. No.: US 2015/0107738 A1
(43) Pub. Date: Apr. 23, 2015

(54) Method and Tire for Improved Uniformity and Endurance of Aggressive Tread Designs Using Scalloped Layering Technique

(71) Applicant: Compagnie Generale Des Etablissements Michelin, Clermont-Ferrand (FR)

(72) Inventors: Daniel Robert Rey, Greer, SC (US); Patrick Vervaet, Clermont-Ferrand (FR); Larry Stephen Satterfield, Moore, SC (US); Almira Aleckovic, Anderson, SC (US)

(73) Assignee: Michelin Recherche et Technique S.A., Granges-Paccot (CH)

(21) Appl. No.: 14/403,319

(22) PCT Filed: May 25, 2012
(86) PCT No.: PCT/US12/39517

§ 371 Date: Nov. 24, 2014

(51) Int. Cl. B60C 11/13; B29D 30/68; B29D 30/58; B60C 11/00; B60C 11/03

(52) U.S. Cl. CPC B60C 11/1307; B60C 11/00; B60C 11/0311; B29D 30/58; B29D 30/68
USPC 152/209.18; 156/265; 156/128.6

(57) ABSTRACT

A tire having aggressive tread features with improvements in uniformity that can also improve endurance is provided along with a method and apparatus for manufacturing such a tire. The tire and its manner of manufacture can achieve a reduction or elimination of certain non-uniformities that can occur during the molding of large tread blocks. This can improve temperature performance to provide increased tire endurance. The present invention further relates to a tire made using such a method and that may have layers of different material properties for different tire performances. In one embodiment, a layering technique that uses at least one layer extending across the full axial width of the tread and having scalloped or notched lateral or axial edges is provided. In yet another embodiment, tread blocks are built upon the scalloped layer(s) to provide more material where it is needed most to create tread features.

### FIELD OF THE INVENTION

The present invention relates to a tire having an aggressive tread pattern and a method of manufacturing the same to improve uniformity and increase endurance. The present invention further relates to tire made using such a method and that may have layers of different material properties for different tire performances. In one embodiment, a layering technique that uses at least one layer that extends across the full axial width of the tread and has scalloped or notched lateral or axial edges is provided. In yet another embodiment, tread blocks are built upon the scalloped layer(s) to provide more material where it is needed most to create tread features.

### BACKGROUND OF THE INVENTION

In general, tires are typically manufactured on a large scale through the build up of various layers onto a tire forming drum. The layers may include e.g., a carcass and other materials that provide the structure of the tire. The sides of these layers are turned up to create a toroid in the form of an uncured, tire intermediate. A layer or portion of tread rubber is then added to the tire intermediate to create what is sometimes referred to as a green tire. Often, the tread rubber is flat or featureless required tread blocks, ribs and other tread features to be added later. The green tire is subsequently cured by the addition of heat and pressure in a curing press.

The walls of the curing press typically include mold features for molding a tread design or tread pattern into the tread portion of the green tire. These mold features may provide e.g., tread blocks of various shapes and configurations with one or more grooves separating the tread blocks from each other. Various sipes or lamelles may be added into the tread blocks as well. These features provide suitable tire performances such as traction in dry, snowy, wet or muddy conditions.

With aggressive tread designs, challenges to tire uniformity can be encountered in the conventional manufacturing process summarized above. As used herein, “aggressive” refers particularly to tread designs having deep (along the radial direction) and sometimes large tread blocks along the tread portion of the tire. Such designs can be commonly found, e.g., in military vehicle and off-road vehicle applications. In the manufacture of such tread designs, a large amount of the tread rubber from the tread portion of the green tire must be forced into mold features such as the cavities or apertures that create the tread blocks. Accordingly, a substantial amount of pressure is applied to displace this tread rubber and mold the tread features.

Some examples of off-road tires that have aggressive tread designs include agricultural, earthmover and mining tires. An illustration of an agricultural tire 50 is shown in FIGS. 1 and 2 that has a particularly aggressive tread design in that the lugs are deep and rise above the base level of the tread a significant amount. As can be seen in FIG. 2, the base layer 52 of the tread is quite curved as it travels from the crown of the tread to the shoulders of the tread. At the same time, the height or curvature of the top surface 54 of the lugs changes only slightly. This results in a shallower groove depth Dᵢ at the crown of the tire, and a much deeper groove depth Dₛ at the shoulders. As a result, the amount of rubber that must flow or be displaced from the shoulder regions of such tires is greater than in other parts of the tire. The flow of the rubber in a mold in these areas is difficult to control and typically requires up to 10% additional rubber volume to be provided in order to successfully mold out the shoulder features. This is more than is necessary to obtain the desired tire performance.

Unfortunately, this required displacement of the tread portion to form the tread blocks can also cause undesired displacement of one or more the layers of the green tire that are located next to the tread portion. For example, the carcass and/or other layers can also be displaced to create local effects such as waves, bumps, undulations, or other undesirable irregularities that make the tire non-uniform along the circumferential and/or axial directions. Breaking belts can also be distorted by the displacement of the tread portion. Such non-uniformity can create undesirable endurance problems for the tire by e.g., creating areas where unwanted temperature increases can occur during tire operation and thereby effecting tire endurance.

By way of further example, FIGS. 3A and 3B show the displacement of the carcass ply of a tire similar to that depicted in FIGS. 1 and 2. In this example, the displacement of the rubber causes the breaker ply to be pushed upward causing a wave or bump in the ply. The amount of the wave 56 is greatest, as shown in the top depiction of FIG. 3A, in the lug itself due to the amount of rubber that is displaced to make the lug. On the other hand, the amount of wave 58 is lesser in the grooves found between the lugs, as shown in the lower depiction of FIG. 3B due to the fact that less rubber needs to flow or be displaced in this area. However, such a distortion no matter how great can have a negative impact on the endurance of the tire.

Accordingly, a tire that can be manufactured with an aggressive tread pattern in a manner that can reduce or eliminate certain non-uniformities such as wavy belts or carcasses would be useful. More particularly, such a tire that can be manufactured through a method that can help eliminate undesired displacements of various layers of the tire during the molding process without requiring a great amount of excess rubber and increased cycle time would be helpful. Such a tire and a method of manufacture that can provide improvements in endurance would also be beneficial.

### SUMMARY OF THE INVENTION

Aspects and advantages of the invention will be set forth in part in the following description, or may be obvious from the description, or may be learned through practice of the invention.

In one exemplary embodiment, the present invention provides a tire intermediate defining axial, radial, and circumferential directions. The tire includes a pair of sidewalls opposed to each other along the axial direction and a tread portion extending between the pair of sidewalls. The tread portion has a base and at least one layer having at least one lateral edges with scallops thereon where the scalloped layered is laid on the base and has a configuration such that the scallops align with features of a mold that form the grooves of the cured tire. There may be a plurality of scalloped layers that have scallops on both lateral edges and are stacked along the radial direction of the tire. The size of the layers may decrease successively along the radially-outward direction. Also, these layers may have ground faces and edge faces where may be an offset between the edge faces. This offset may increase in the scalloped areas where the grooves of the tire are formed during molding.

In another exemplary aspect of the present invention, a method of manufacturing a tread portion for a tire is provided, the tread portion having tread blocks constructed from layers of tread rubber. The method includes the steps of providing a base of tread rubber; supplying a sheet of tread rubber for constructing at least one layer; cutting the sheet of tread rubber with scalloped portions on at least one of its lateral or axial edges, each scalloped portion forming a groove when the tread is cured; and placing at least one layer on the base at a predetermined location. The step of cutting may further comprise cutting a plurality of scalloped layers with scallops found on both lateral edges, said layers having different sizes and the method may further comprise the step of stacking said scalloped layers onto one or more layers of the placing step.

In some embodiments of this method, the method further comprises the step of providing a building drum and said step for providing a base rubber comprises applying a sheet of rubber to the drum as it rotates. Also, the step for placing the layers could comprise feeding the layers onto the drum on top of the base rubber as the drum rotates.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of an agricultural tire having an aggressive tread design.

FIG. 2 is a side view of the tire of FIG. 1 showing the increased lug depth near the shoulder of the tire.

FIGS. 3A and 3B show the distortion of tire components associated with the conventional manufacturing of aggressive tire tread designs.

FIG. 4 provides a perspective view of a portion of the toroid of an exemplary embodiment of a tire intermediate constructed according to the present invention.

FIG. 5 provides a cross section view, taken along line 5-5 in FIG. 4, of an exemplary embodiment of a tread block of the present invention.

FIG. 6 provides a perspective view of certain aspects of an exemplary method and apparatus of the present invention as may be used to manufacture a tread portion, an exemplary embodiment of which is also shown in process.

FIG. 7 provides a perspective view of certain aspects of an exemplary method and apparatus of the present invention as may be used to manufacture a tread portion, an exemplary embodiment of which is also shown being wrapped onto a tire intermediate.

FIG. 8 provides a partial cross-sectional view of an exemplary embodiment of a tread block inserted into an exemplary mold cavity.

FIG. 9 illustrates an exemplary embodiment of a cutting wheel as may be used with the present invention.

FIG. 10 shows a tire that has an aggressive tread design and that was manufactured according to an embodiment of the present invention and according to conventional methods and for which temperature readings were taken to show the endurance improvement provided by the present invention.

FIG. 11 is a cross-section of the tire of FIG. 10 showing where exactly the temperature readings were taken.

FIG. 12 is a side view of yet another manufacturing system that can be employed to create layered tread blocks.

FIGS. 13 and 14 show two possible band configurations or tread block configurations that can be made by the system of FIG. 12 depending on the programming of the system.

FIGS. 15A thru 15C show various views of layered tread blocks that are laid onto a flattened illustration of one tread design that can be made using the system of FIG. 12.

FIG. 16 depicts two more layered tread block configurations that can be made using the process illustrated by FIG. 12.

FIG. 17 is a schematic showing how equipment designed to make smaller tire treads can be used to create tire treads for larger tires.

FIG. 18 shows an example of the use of scalloped layers for creating tread lugs and grooves.

FIGS. 19 and 20 show two different sides of the midplane of a tire intermediate using scalloped layers with cross-hatching showing the top surface of the top layer and top surface of the base layer found at the bottom of a notch.

FIG. 21 shows the relative position of the notches to the final desired groove and lug geometry after cure, with only one instance of the final lug being shown for clarity.

FIG. 22 illustrates the flow of the rubber shown in cross-hatching in FIGS. 19 and 20 using similar cross-hatching for the cured tire.

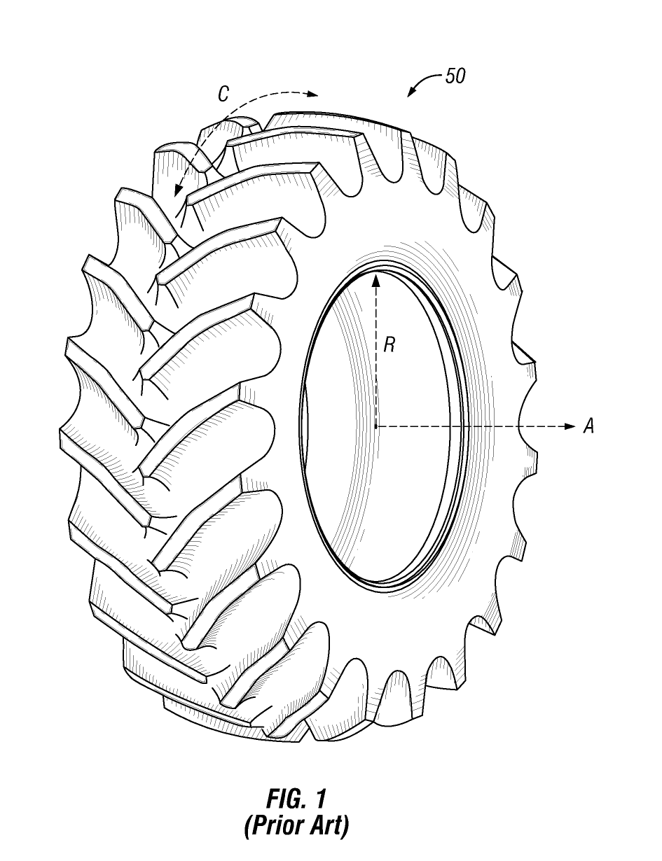

The use of identical or similar reference numerals in different figures denotes identical or similar features.

### DETAILED DESCRIPTION OF THE INVENTION

The present invention provides for a tire having aggressive tread features with improvements in uniformity that can also improve endurance. More particularly, the present invention provides a tire constructed by a method that can reduce or eliminate certain non-uniformities that can occur during the molding of large tread blocks or lugs that have great depth especially near the shoulder regions of the tire. The reduction or removal of these non-uniformities can improve temperature performance to provide increased tire endurance. For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

As used herein, “tread rubber” refers to a variety of possible compositions—natural and synthetic—as may be used to construct various portions of a tire. Different layers of a tire may have different properties for providing desired tire performances.

“Tire intermediate,” as used herein, refers to a tire construction that may need additional processing steps before use such as curing and/or molding in a tire curing press. This is often referred to sometimes as a green tire or intermediate tire.

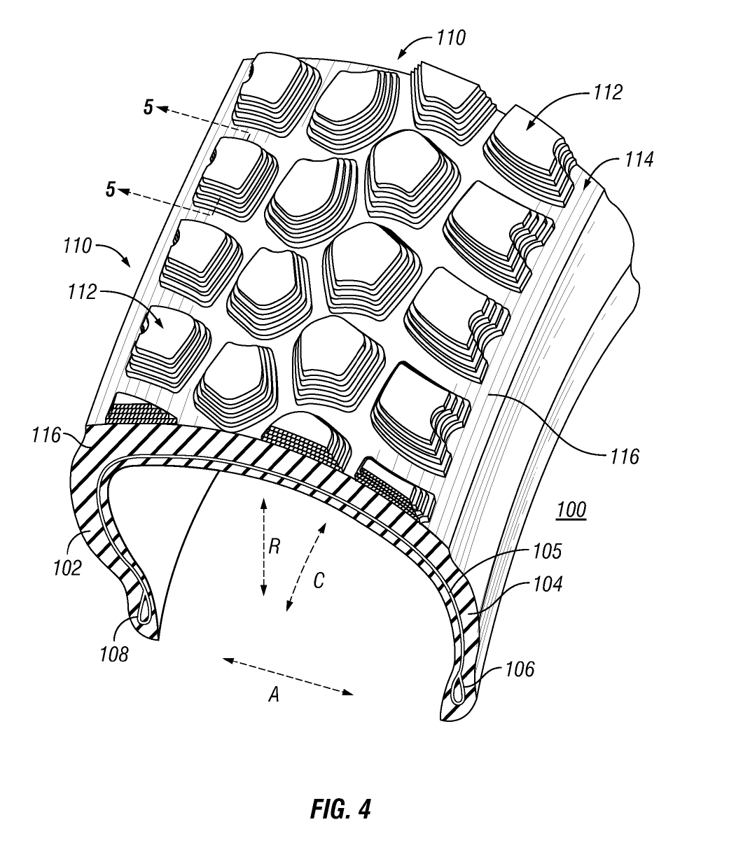

FIG. 4 provides a perspective view of a portion of the toroid of an exemplary embodiment of a tire intermediate 100 constructed according to the present invention. Tire intermediate 100 includes a pair of sidewalls 102 and 104 opposed to each other along axial direction A. Bead portions 106 and 108 are located at the end of sidewalls 102 and 104. A tread portion 110 extends between sidewalls 102 and 104. A carcass layer 105 extends between bead portions 106 and 108 and under tread portion 110.

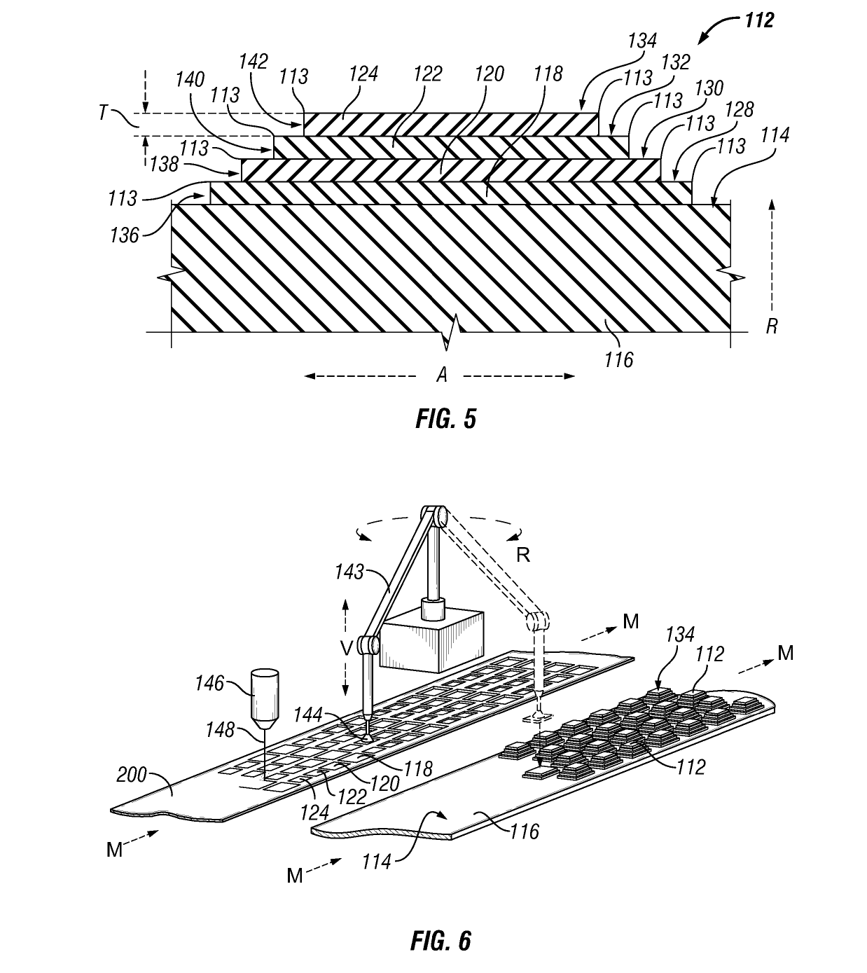

Tread portion 110 includes a tread pattern created by an arrangement of multiple tread blocks 112 spaced along axial direction A and circumferential direction C. The resulting tread pattern can be considered aggressive in that blocks 112 are relatively thick along radial direction R and are also relatively large in terms of the volume of tread rubber projecting above surface 114 that makes up each block 112. The particular tread pattern shown is by way of example only. The present invention may be used with a variety of other configurations or patterns of tread blocks. As shown in FIG. 5, the layers 118, 120, 122, and 124 of tread block 112 have substantially the same thickness T. However, using the teachings disclosed herein, it will be understood that variations in thickness T between layers may be used as well.

It is also contemplated that the layers may be made of different materials having different properties that can satisfy different tire performances in the final or cured tire. For example, the base layer could be made of a material that is good for preventing puncture of the tread by objects while the layers that are used in the tread blocks or lugs could be formed of materials that are good for traction, wear, prevention of tearing, improved rolling resistance, etc. Furthermore, the layers within the blocks themselves could be made from different materials depending on the desired tire performances and balance between performances such as traction and rolling resistance by way of an example.

Referring now to FIGS. 4 and 5, each tread block 112 includes a plurality of layers of tread rubber 118, 120, 122, and 124. First layer 118 is positioned upon a base 116 that extends along circumferential direction C between sidewalls 102 and 104. While only four layers are shown, using the teachings disclosed herein it will be understood that fewer or more layers may be used to construct a tread block of the present invention and the embodiments shown in the figures are exemplary only. As shown, layers 118, 120, 122, and 124 are stacked along radial direction R and decrease successively in size moving outwardly (up from the reader's perspective in FIG. 5) along the radial direction R. For example, the width along axial direction A of layer 120 is less than such width for layer 118, and so forth for the other layers 122 and 124.

Stated alternatively, the layers 118, 120, 122, and 124 decrease in size along the radially outward direction R such that these layers are stepped as shown in FIG. 5. As a result, each layer has an edge face that surrounds a ground face. More particularly, first layer 118 has an edge face 136 that surrounds ground face 128; second layer 120 has an edge face 138 that surrounds ground face 130; third layer 122 has an edge face 140 that surrounds ground face 132; and fourth layer 124 has an edge face 142 that surrounds ground face 134. The surface area represented be each edge face decreases between successive edge faces along the radially outward direction. For example, the surface area of edge face 138 is less than the surface area of edge face 136. It is further contemplated that while the layers are shown as one solid layer that they themselves could be split or subdivided into one or more thinner layers that have the same peripheral dimensions. That is to say, their edge faces would be aligned. However, it is contemplated that the layers could increase in size as one progressives in the upwardly radial direction as would be case if trying to create negative draft angles in the groove between the tread blocks or that layers could be relatively the same size if little draft is necessary or wanted.

FIG. 6 provides a perspective view of certain aspects of an exemplary method and apparatus of the present invention as may be used to manufacture tread portion 110. As shown, a sheet of tread rubber 200 is supplied along machine direction M for constructing layers that make up tread block 112. A cutting device such as a water jet cutter 146 provides a stream 148 of water under high pressure that is directed towards sheet 200. An x-y machine (not shown) or other control device moves cutter 146 to cut sheet 200 into individual portions that each form one of layers 118, 120, 122, or 124 making up tread block 112. As sheet 200 is advanced along machine direction M, a robotic arm 143 with a suction element 144 or other selection device then individually selects the portions making up layers 118, 120, 122, or 124 and sequentially positions each layer onto base 116 (as indicated by arrows V and R and the phantom representation of arm 143). A controller (not shown) operates robotic arm 143 to position each layer at predetermined locations on base 116 and to stack the layers (smaller layers on top of the larger layers) to create tread blocks 112. For this exemplary method, base 116 is also conveyed along machine direction M in a manner parallel to the movement of sheet 200.

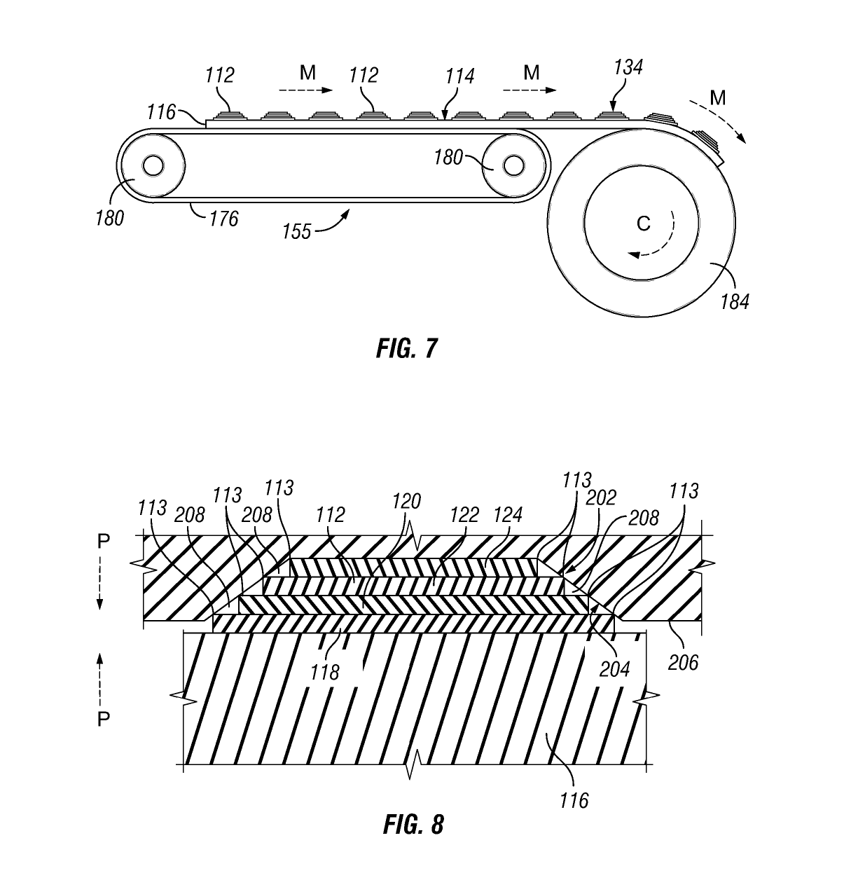

Turning to FIG. 7, after each tread block 112 has been constructed, tread portion 110 is advanced along machine direction M by, for example, a conveying device 155 having an endless belt 176 carried on rollers 180. Tread portion 110 (including base 116 and tread blocks 112) is fed to an untreaded tire intermediate 184 and wrapped around intermediate tire 184 as shown by arrow C in FIG. 7. The resulting tire intermediate 110 can then be e.g., placed into a curing press for the application of heat and pressure.

After such curing, it should be understood that the stepping of individual layers 118, 120, 122, and 124 as shown in FIGS. 4 through 7 may no longer be plainly visible. FIG. 8 illustrates a cross-section of an aperture or cavity 202 defined by a wall 204 of a mold 206 as can be part of a curing press. As tread block 112 is pressed into mold 206 (arrows P), layers 118, 120, 122, and 124 initially contact wall 204 only tangentially at the intersections of the edge face and ground face of such layers. As heat and pressure are applied by the mold, layers 118, 120, 122, and 124 assume the shape provided by mold wall 204. In addition, first layer 118 provides additional tread rubber that helps fill voids 208. By carefully predetermining the volume of each of layers 118, 120, 122, and 124, the volume of tread rubber making up the final, cured tread block 112 is substantially the same as the total volume of tread rubber provided by layers 118, 120, 122, and 124. As a consequence, the additional tread rubber needed to fill voids 208 does not come from base 116, which might cause non-uniformities such as e.g., a local displacement of carcass 105 (FIG. 4) and/or breaking belts located radially outward of the carcass in the crown region of the tire. Instead, substantially all of the tread rubber is provided by layers 118, 120, 122, and 124 to avoid local effects that lead to non-uniformities.

Put into other words, the corners or intersections 113 of the edge face and ground face of the layers are strategically placed so that they are aligned with contour of the cavity wall as the mold or curing press is closed, minimizing the amount of material flow necessary to form the tread lugs or blocks. While this example shown in FIG. 8 shows an angled or linear cavity wall, which necessitates a linear progression of the layers and their intersections, it is contemplated that the wall of the cavity and associated final shape of the blocks after cure, could be any shape desired including curved meaning that the progression of the layers and their intersections would not be linearly arranged but instead would follow a path that mimics that of the cavity wall so that the intersections of the layers will touch the cavity wall at about the same time as the mold or press closes. In such a case, the thickness of the various layers may also be different in order to accommodate the gradient of the flow of rubber necessary to make the final or cured configuration of the tread block from one area of the block to another.

For tires having particularly deep lugs or tread blocks as is often the case for agricultural tires, the inventors have found that it is best that the height of the staggered layers approach the desired final height of the lug after cure and that the perimeters of the staggered layers be greater than the perimeter of the mold cavity if the mold design permits. So unlike what is shown in FIG. 8, the topmost surface of the staggered layers would not be substantially touching the bottom surface of the mold cavity (i.e. there would be a small gap) when the side walls of the cavity contact the corners or intersections of the staggered layers and not necessarily every corner or intersection will be contacting a cavity wall initially. However, it is still desirable to have the majority of the corners or intersections touching the cavity wall at approximately the same time as the mold closes in order to minimize the amount of material flow found near the base layer of the tread, which is where undesirable deformations of tire components is apt to occur.

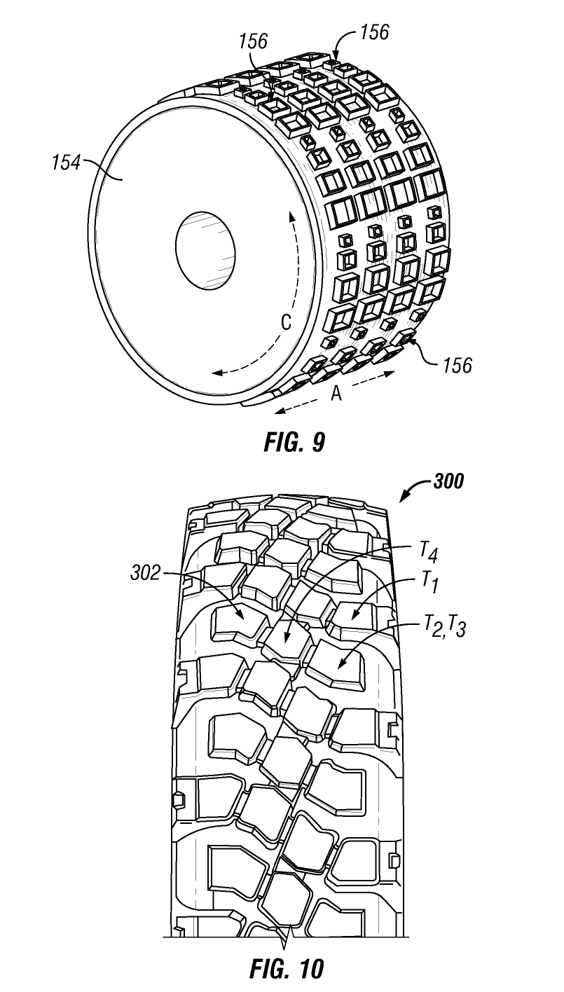

Alternatively, the layers may be cut using a cutting wheel 154 with blades 156 configured to shape the perimeter of the layers as desired. These blades may be similar to those used in cookie cutter type applications. The configuration of such a wheel is shown in FIG. 9. This is given by way of example only and others may be used as well. This wheel has blade perimeters that successively get larger as one progresses circumferentially C around the wheel and similarly shaped blades are found axially A across the width of the wheel. One with ordinary skill in the art can quickly recognize that this cutting wheel may be substituted for the cutting device shown in FIG. 6 in order to produce the same configured layers as shown there. This may be a faster method to produce the desired stacked blocks as the use of wheel may enable the process to be continuous with the creation of layers being performed simultaneously across the width of the sheet whereas to use a water jet would necessitate stoppage of the sheet until all the layers had been completed across the width of the sheet. In order to keep this gain in reduction in production time, it would be necessary to have multiple suction cups or selection devices that picked up the layers from across the sheet and place them onto the base layer of the tread simultaneously. Of course, any variation of tread block geometry could be created from one tread block to the next in any direction including axial A and circumferential C by simply modifying the cutting path of a water jet or the perimeter of a cutter blade.

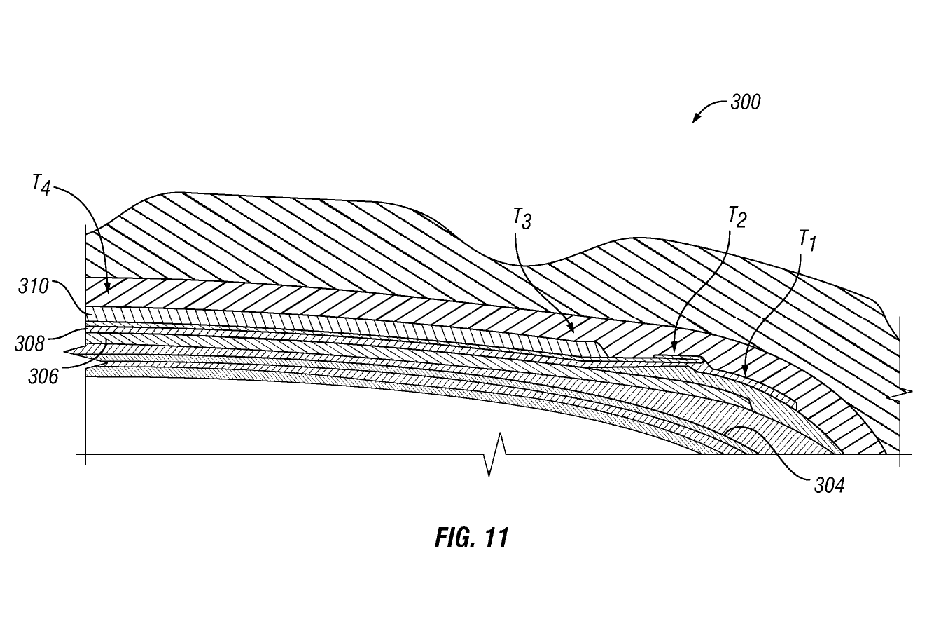

FIG. 10 provides another example of a tire 300 having aggressive tread blocks 302. A cross-section of tire 300 is shown in FIG. 11. Tire 300 includes a carcass 304, first belt 304, second belt 308, and third belt 310. Table 1 provide the results of an evaluation of the differences in temperature that can be achieved when tread features such as aggressive tread blocks 302 are provided through conventional tire molding and curing as compared with creating such features before the traditional curing step.

TABLE I

| | | Temp ° C. | |
|---|---|---|---|
| | Temp ° C. | Blocks formed | |
| Location | Conventional Mfg. | Pre-Cure | Δ ° C. |
| T₁ | 117.5 | 108.5 | −9.25 |
| T₂ | 117 | 98.25 | −18.75 |
| T₃ | 107.25 | 96.75 | −10.5 |
| T₄ | 99 | 100 | 1 |

Each row represents a temperature as determined in different positions T₁, T₂, T₃, and T₄ of the crown of a conventionally manufactured tire 300 versus a tire 300 having aggressive tread blocks created before the tire curing process after the tires had reached steady state after running a suitable period of time. As shown in Table 1, substantial reductions in temperature can be achieved at certain locations. These reductions can substantially improve the endurance of the tire. Additionally, the data suggest that substantial temperature improvements are more likely to occur near the lateral edges of the belts 304, 308, and 310, which is likely because the edge of a belt can be more readily displaced during a conventional molding process as rubber located above (radially-outward of) the belt is displaced into a mold cavity.

Another process that the inventors have identified as being suitable for creating the desired layers and configurations of tread blocks is that disclosed in U.S. Patent Application Publication No. 2011036485, which is commonly owned by the assignee of the present invention and whose content is incorporated by reference for all purposes in its entirety. Portions of that application are reproduced herein as follows to describe how the process works and how it can be used in conjunction with the present invention. It is desirable to use this process as it can be done continuously, minimizing the amount of time necessary to fabricate the green tire.

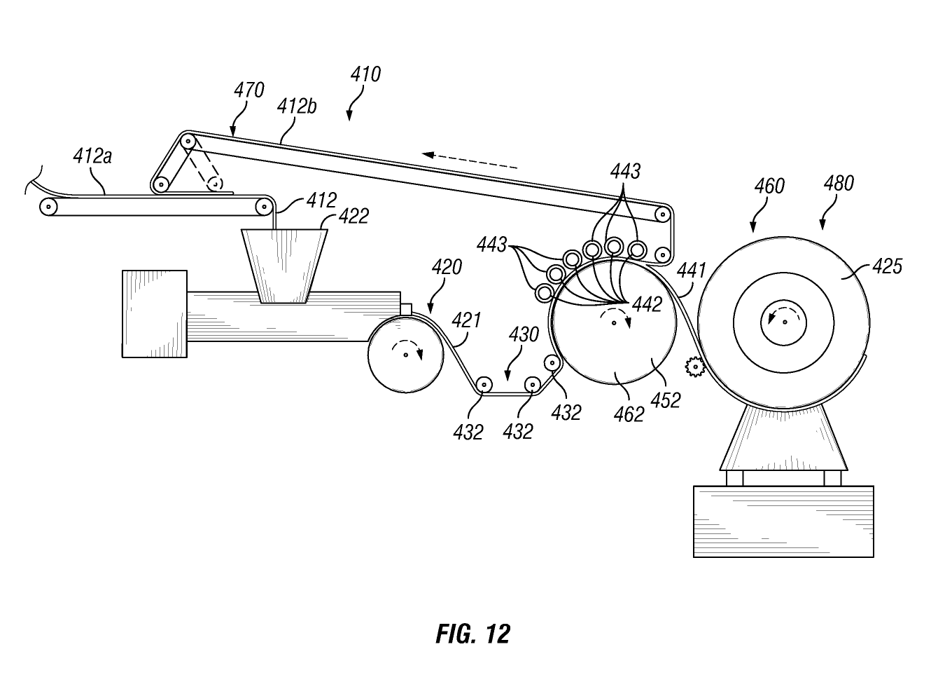

A system 410 for generating a multi-layered tire component in accordance with the methods described in the '485 application is generally shown in FIG. 12. System 410 generally operates to form a multi-layered tire component by winding strips 441 about a building surface. Because tire component is a wound product, it generally forms a complete circle (i.e., a ring). Component is also referred to herein as a band. Also, system 410 generates a sheet 421 from which the strips 441 are formed, and, in particular embodiments, the sheet 421 remains continuous as it travels along a closed-loop path to and from a sheet generator 420. Accordingly, system 410 automatically returns any unused sheet material for reuse by generator 420. System 410 generally forms elastomeric tire components, such as, for example, tread, sub-tread, and cushion gum. It can also create a multi-layered band that is a profiled tire tread band.

In this embodiment, system 410 comprises a sheet generator 420, a cutting assembly 440, a strip applicator assembly 460, a recovery assembly 470, and a programmable logic controller (not shown). System 410 may also include a roller assembly 430 for directing a sheet 421 from generator 420 to cutting assembly 440. Sheet generator 420 generally transforms input material 412 into a sheet 421, which is ultimately cut into strips 441 by cutting assembly 440. With continued reference to FIG. 12, input material 412 is received through inlet 422, and may comprise new material 412a and/or previously used material 412b supplied by recovery assembly 470. After receiving input material 412, generator 420 forms the input material by any known means into sheet 421, where sheet 421 is formed to any desired width and thickness. Sheet 421 is expelled from generator 420 by way of outlet 424.

In one embodiment, as shown in FIG. 12, generator 420 comprises an extruder. Extruders generally push input material 412 through a die or head, such as by way of a screw. Any extruder known to one of ordinary skill in the art may be used by system 410. Generator 420 may also comprise a calender, in lieu of an extruder, which may comprise a pair of rollers positioned in close proximity to each other to form a gap or nip, through which input material 412 passes to from a sheet 421. The resulting sheet 421 includes a width associated with the width of the calender nip. While an extruder and calender are capable of operating at similarly high speeds, a calender may not accelerate as quickly to attain a desired speed, as it may take more effort and time to accelerate the rotational inertia of the calender rolls. This may affect the start-up time of system 410, as well as the responsiveness of system 410 to restart after a temporary delay.

An extruder, however, typically applies significantly more heat to the input material than a calender during processing, which negatively affects scorch and other properties and, therefore, reduces the reprocessing life of the material used in system 410. An extruder may also perform more work upon the input material, with at least reduced the fluidity of the material during its lifetime, which again reduces the life of such material. It is contemplated that an extruder can be used with a calendar to produce the desired sheet properties and dimensions.

As shown in FIG. 12, a roller assembly 430 may be located between sheet generator 420 and cutting assembly 440. Roller assembly 430 generally comprises one or more rolls 432 arranged to form a translation path of sheet 421. The particular translation path directs sheet 421 to cutting assembly 440, and may be used to tense or stretch sheet 421 as desired. The location of rolls 432 may be adjusted to impart more or less tension on sheet 421, which may also provide a means for adjusting the cross-sectional dimensions of sheet 421. One or more rolls 432 may be driven or powered, such as, for example, by a motor, to assist in the translation of sheet 421, and/or adjustment of tension in sheet 421. Sheet 421 may also be tensed by creating a speed differential between drum 425 and/or cutting drum 452, by increasing or decreasing the rotational speed of either drum. A calender system may also operate as a tensioning system, as the sheet translates about rolls (not shown).

Cutting assembly 440 generally forms strips 441 from sheet 421 for subsequent assembly of the tire band. More specifically, cutting assembly 440 utilizes a plurality of cutting members 442 to cut strips 441, wherein each cutting member 442 includes a cutting edge 443. Cutting members 442 generally are spaced along a length of sheet 421, and along a circumference of cutting surface and/or cutting drum 452. In the embodiment shown in the FIGURES, cutting members 442 are rotating knives. Rotating knives, in the embodiment shown, operate similarly to idler wheels, and freely rotate at the direction of the translating sheet 421. Still, rotating knives 442 may be driven by a motor or any other known driving means. Also, other means for cutting sheet 421 known to one of ordinary skill in the art may be used in lieu of rotating knives, including other non-rotating knives, blades, or edges. Furthermore, a cutting wheel such as shown in FIG. 9 may be used.

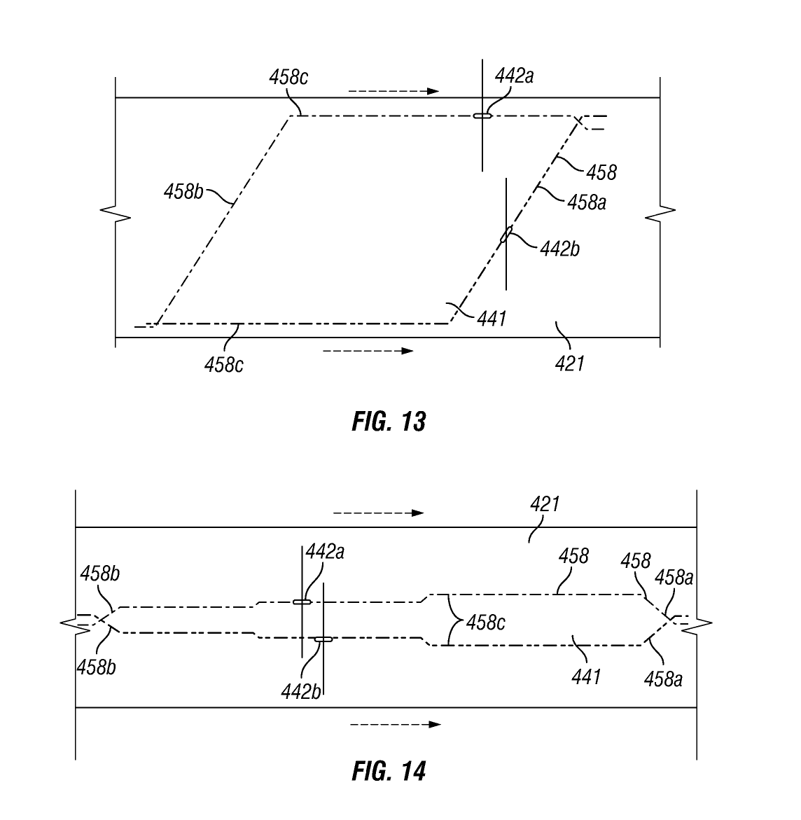

To cut strips 441 at desired locations along sheet 421, cutting members 442 translate laterally along a width of sheet 421 (i.e., in a sideways direction of sheet 421). Translation is achieved by translation members (not shown), each of which may comprise, without limitation, a linear actuator, a servo motor, a pneumatic or hydraulic cylinder, or any other translation means known to one of ordinary skill in the art. Translation members generally translate along a linear translation axis, but it is also understood that non-linear translation may occur. For example, a cutting member 442 may translate by way of translation member, which is mounted to a side of sheet 421. Also, cutting member translation may be achieve by translation member, which translates about a rail (not shown) or the like that is mounted above sheet 421. Each cutting member 442 may also be capable of extending up and down from rail by an extension member, which may comprise any means of extending, such as, for example, a servo, solenoid, cylinder, which may be pneumatic or hydraulic. Each cutting member 442 may also be capable of rotating in angled relation to the direction in which sheet 421 is translating, as shown in FIG. 13. Such rotation may improve the ability of cutting member 442 to perform a transverse cut along a width of sheet, such as shown in FIG. 13. Cutting member 442 may rotate at any angle in any direction.

In one embodiment, cutting member 442 rotates approximately 45 degrees from the translation direction (i.e., the direction of travel) of sheet 421. Rotation may be achieved by a rotation member (not shown), which may comprise an electromagnetic solenoid, or any other means of rotating a cutting member 442 that is known to one of ordinary skill in the art. Controller generally controls the operation and movement of cutting members 442 by operation of translation members, extension members, and rotation members. Controller may cooperate with a single or multi-axis motion controller to synchronize and coordinate the operation and movement of the cutting members 442.

In operation, cutting members 442 cut a path 458 along translating sheet 421 to form one or more strips 441. In one embodiment, a pair of cutting members 442 cuts a closed-loop path 458 to form a strip 441, as shown in FIGS. 13-14. Path 458 circumscribes strip 441, and may comprise a leading edge 458a, a trailing edge 458b, and one or more 100 side edges 458c. Leading edge 458a and trailing edge 458b, each of which form a beginning and end of strip 441, respectively, may also operate as a side edge 458c, such as when cutting a strip 441 comprising a tear-shape or a 4-sided diamond-shape. In one embodiment, a pair of cutting members 442a, 442b is able to form a strip 441 within sheet 421 while sheet 421 is operating in a closed-loop path, where such pair is by being placed 105 in a staggered arrangement along a length of the sheet 421. This staggered arrangement allows a downstream, or subsequent, cutting member 442b to cut a path that intersects a preceding path formed by the upstream, or preceding, cutting member 442a, as shown in FIGS. 13-14. This intersection may be used to form a beginning and end of each strip 441, which refer to the leading and trailing edges 458a, 458b, respectively. Leading and/or trailing edges (i.e., the beginning and ending of strip 441, respectively) may be cut by an additional cutting member 442 that is dedicated to making either or both such cuts. Cutting members 442 may translate while cutting sides 458c, such as, for example, to adjust or taper (i.e., increase or decrease) the width of strip 441, or to otherwise vary the shape and/or size of strip 441.

With general reference to FIG. 12, system 410 also includes an applicator assembly 460 for applying one or more continuous strips 441 to a building surface to form a band. The one or more strips 441 are wound about the building surface to form the multi-layered band. Applicator assembly 460 includes an applicator drum 462 that transfers one or more strips 441 there from to building assembly 480. To provide adhesion between applicator drum 462 and strips 441, which promotes the separation of strips 441 from sheet 421, applicator drum 462 may be heated or cooled. In particular embodiments, applicator drum 462 is maintained at a temperature at least 10 degrees Celsius higher than the temperature of sheet 421 and/or any strips 441. In other embodiments, applicator drum 462 is maintained at approximately 70 degrees Celsius. The surface of applicator drum 462 may comprise a smooth surface, which may be a chromed or hot chromed surface, so to provide a smooth, capillary-like surface that may promote molecular bonding and/or may operate like a vacuum to facilitate retention of strips 441 thereon. Improved adhesion may also be provided by providing a rough surface, the rough surface providing increased surface area for improved contact area, and therefore, increased adhesion. Applicator drum 462 may also operate as the cutting drum 452. Further, the temperature controls and conditions, as well as the surface conditions and treatments discussed with regard to applicator drum 462 above may also be applied to cutting drum 452 to improve adhesion between drum 452 and sheet 421.

While this process has until now only be used to create continuous strips or bands around the circumference of the tread of a tire, the inventors have recognized that by changing the programming of the controller, layers for tread blocks that are not continuous around the circumference of the tread can be made. Consequently, they proceeded to create such layered tread blocks, lugs, or barrettes for an agricultural tire as will now be described.

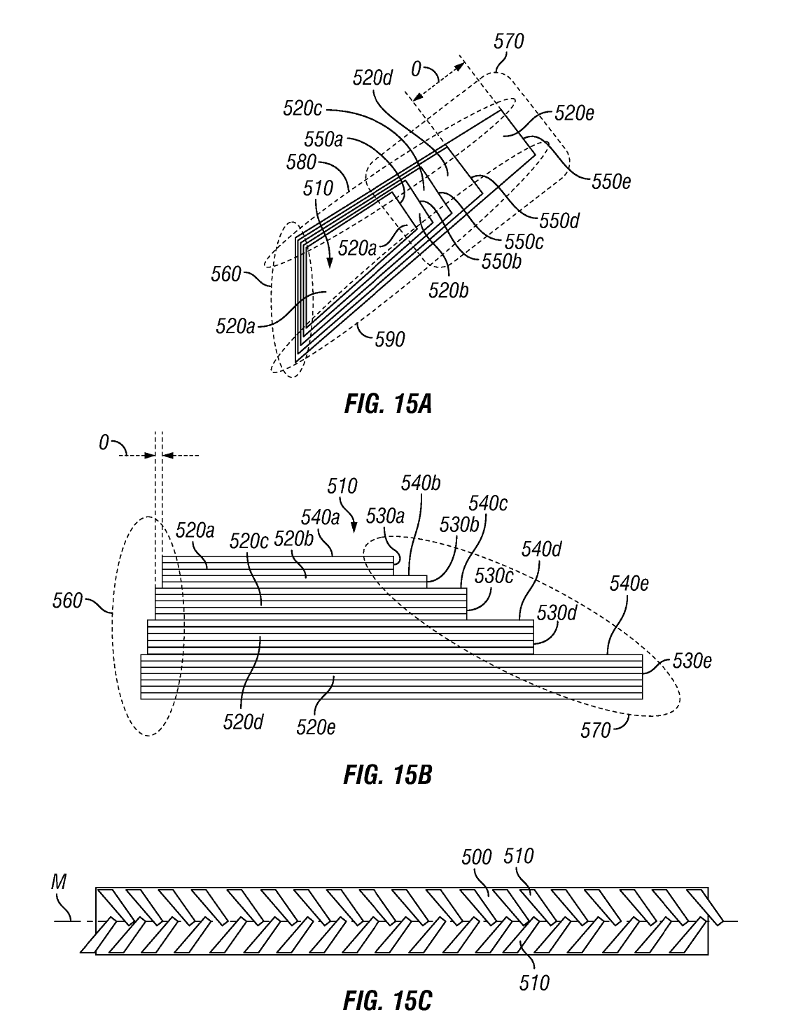

Turning to FIG. 15C, there is shown the flattened profile of a tread for an agricultural tire that is 370 mm wide and is 3020 mm long. It has a base layer 500 and layered tread blocks 510 that alternate from one side of the midplane M of the tread to the other such that the beginning of one tread block on one side of the midplane is located between the beginning and end of a tread block on the other side of the midplane and vise versa. This particular configuration provides 19 tread blocks in total on either side of the midplane. A top view and cross-section view of these layered tread blocks is also given in FIGS. 15A and 15C respectively that shows five such layers 520 that are each subdivided into mini-layers such that each aggregate layer 520 has an edge face 530 and ground face 540 that have intersections 550, all as previously described for other embodiments. It should be noted that the amount of staggering or offsetting between the various layers is different in the area 560 near the shoulder as compared to the area 570 nearer the midplane of the tire.

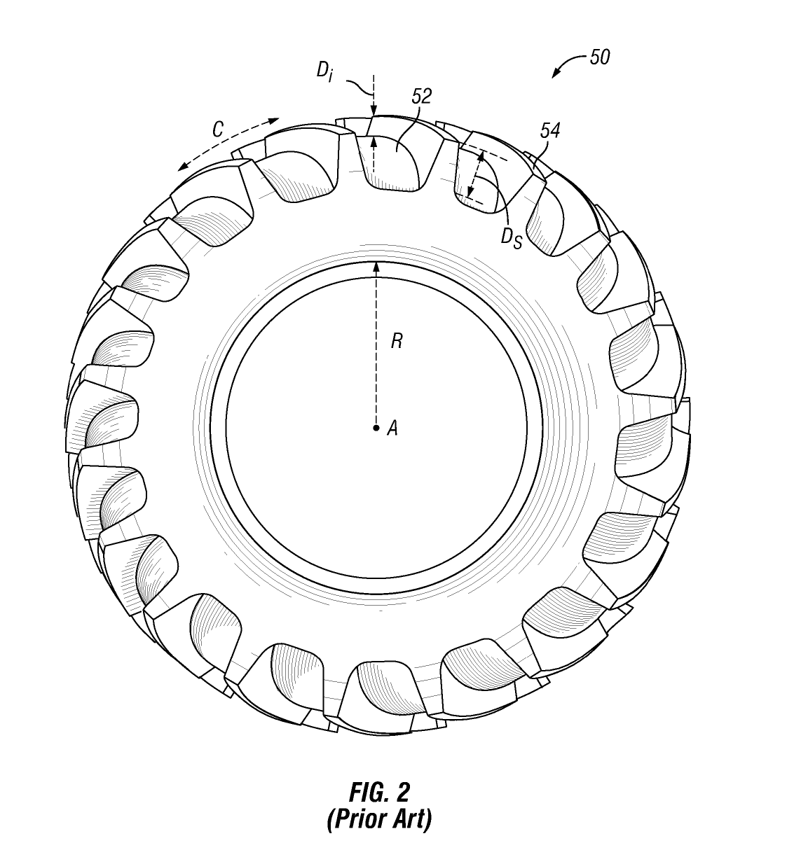

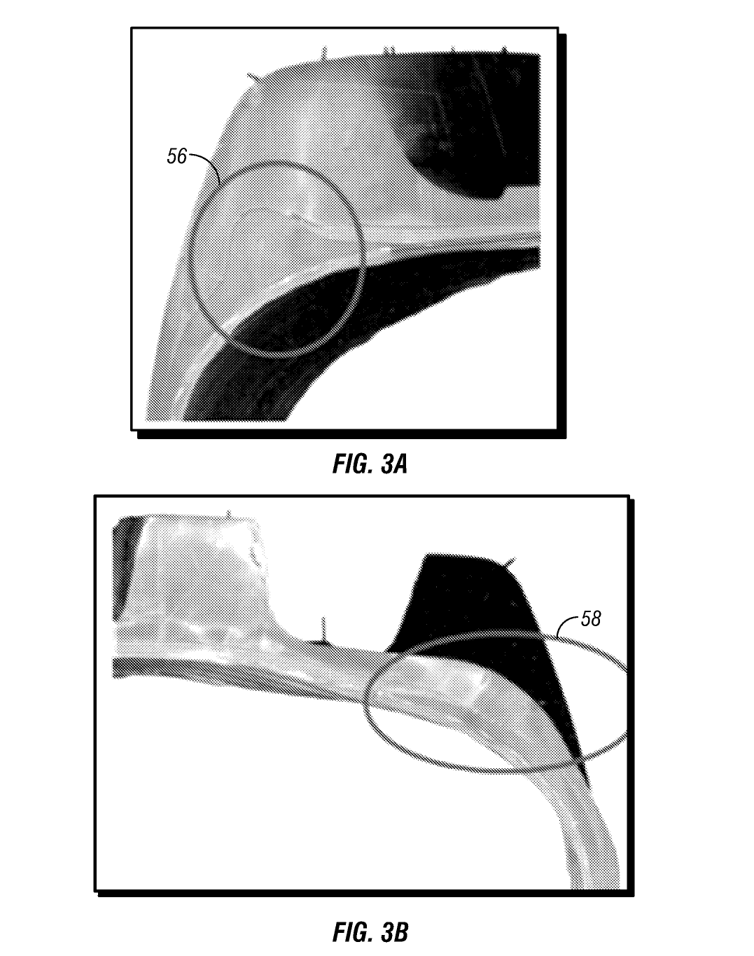

The inventors have found that for tread blocks or lugs (sometimes called barrettes by the inventors) that are relatively long and that have greater height near the shoulders than in the area nearer the crown of the tire, as described and shown in FIG. 2, that it is preferable to have less staggering or offsetting O between the layers near the shoulder where the most material is needed to form the lug and more staggering or offsetting between the layers near the crown where less material is needed. This minimizes the amount of flow necessary to make lugs and the associated risk of distortion for components of the tire beneath the tread when molding the tread. As shown, the amount of the staggering or offsetting of the layers proximate the leading and trailing edges 580, 590 can also be varied from each other depending on the final desired block geometry and predicted amounts of material flow. Therefore, it is contemplated that a gradient of the staggering or offsetting could be found anywhere around the perimeter of a layered tread block as needed.

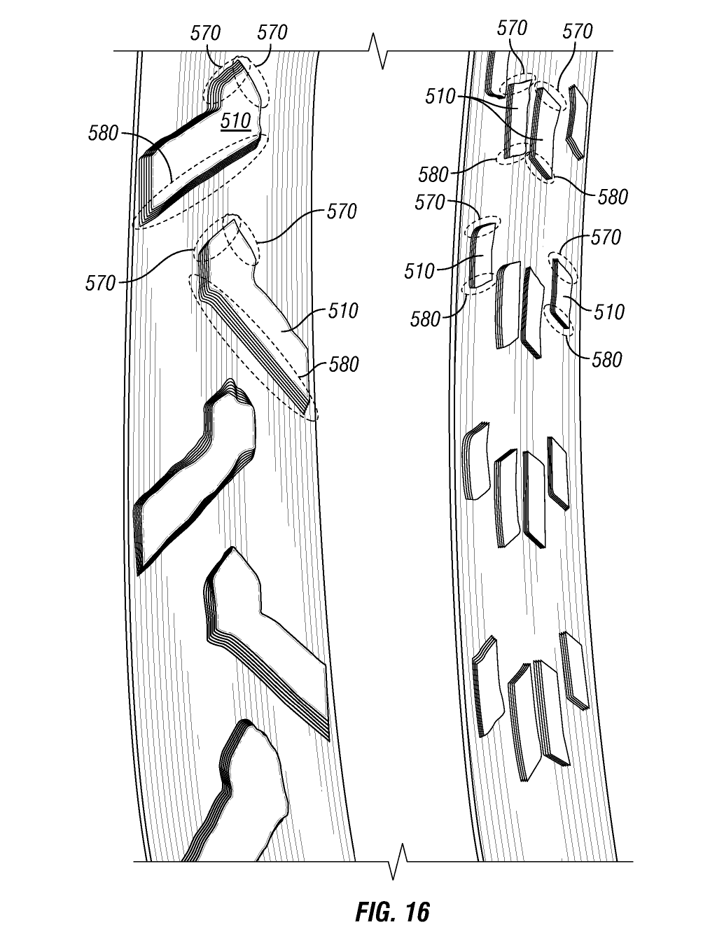

Of course, the configurations of the tread blocks can be varied and FIG. 16 shows two other possible configurations of the layered tread blocks 510. In general, it is necessary that at least one of the leading edges 580 or trailing edges 590 be angled with respect to the travel of the sheet or base layer 500 in order to allow the sheet to continuously move during the creation and transfer of the layers to the green tire, minimizing production time and cost. However, it is possible for the equipment described herein related to the '485 application to be fitted with means for causing a cutting member to rotate until reaching an angle of 90 degrees with respect to the direction of travel of the sheet and to translate in this direction, allowing a straight axial cut for the leading and trailing edges, provided that the sheet is momentarily held still. However, this negatively impacts the production rate of the equipment and associated tire manufacture.

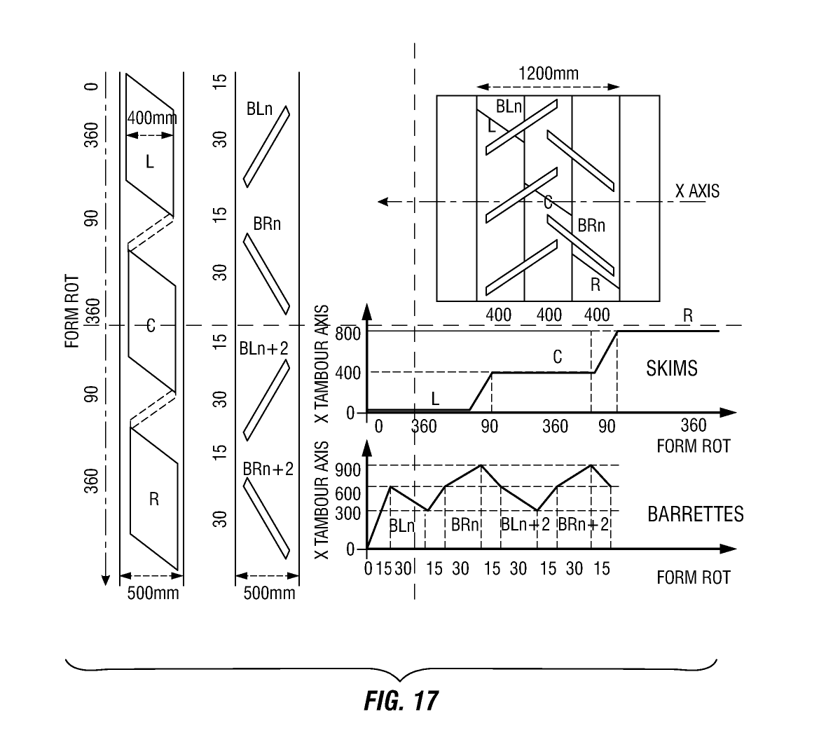

Until this time, the equipment used by the inventors related to the '485 application was sized for use to create treads for passenger car and light truck tires. Based on the typical sizes of such tires, the equipment had a maximum theoretical production width for the sheet or base layer of a tread of 400 mm, meaning the treads just described and shown in FIGS. 16 and 17 could be manufactured using this equipment without any adjustment. But as stated earlier, some of the tires that are prone to belt and carcass distortion due to the molding of aggressive tread designs include those designed and sized to work on very large equipment, such as earthmovers. Consequently, the equipment thus far available is not wide enough to provide the necessary base layer and tread features required to make such tires. The inventors were thus challenged to find a way to adapt the existing equipment so that it could accommodate larger sized tires or make larger equipment that could handle these sizes. The latter option although feasible, may be cost prohibitive depending on the number of larger sized tires and their relatively low amounts of production. Therefore, the inventors set out to seek a solution involving the use of the smaller existing equipment.

Finally, looking at FIG. 17, a solution to this problem is presented in schematic format. It involves the use of a translating building drum upon which the tread components can be laid. This drum can translate in the X or axial direction of the tire/drum so that the tread components can be wound around it in one place and then can transition to another place along the drum as it translates. Put another way, the sheet or base layer can be spirally wound around the drum or one winding can be laid and then other windings along the axial width of the drum using butt joints at the circumferential ends of the various windings and/or along the side edges of adjacent windings (as shown in the top right graph and leftmost graph of FIG. 17). Also, there could be some side to side overlap of sequentially laid windings along the axial length of the drum if desired. This process can be repeated as many times as necessary to cover the effective width of the building drum, thereby maximizing the width of a tire that can be built on that drum. Then, similar layers can be laid sequentially on top of the first layer if so desired. For this embodiment, the effective width of the building drum was 1200 mm, which is large enough to create a tread band for virtually any existing sized tire.

An example of this process includes the following steps as shown in the middle right graph and leftmost graph of FIG. 17. First, the left side of the tread is started by laying the first winding for the base layer completely around the drum for 360 degrees. An angled butt joint is created between the circumferential ends of the first winding along the left part of the tread. Then, the building drum is translated so that the next winding will be immediately next to the first winding of the left part of the tread forming a butt joint along the side edges of these windings. The drum is also rotated 90 degrees before the winding of the center area is laid so that the end joints of the center winding will not be next to the end joints of the left winding. Then, the first winding for the base layer is laid for the center section as the drum rotates for 360 degrees. Another angled end butt joint is created for the first winding along the center part of the tread. Finally, the first winding for the right side of the tread is created using the same steps just described for the center and left sides of the tread. This process can then be reversed in the other axial direction if additional layers for the base are desired. This process continues back and forth until all the necessary base layers have been applied. Of course, this process could be started anywhere on the drum and as such could be started on the right side instead of the left side.

Once the base layer has been completely laid, then the individual tread features such as layered tread blocks may be completed by cutting and winding the strips onto the drum as it rotates in like fashion as just described for the base layer (see second graph from the left and bottommost right graph in FIG. 17). That is to say, the first layer for the first tread block on the left could be laid, then the first layer for the first tread block on the right could be laid, etc. until the first layers for all the tread blocks have been laid around the circumference of the tire intermediate. Then the first layers for the rest of the tread blocks can be created by indexing one full tread block on the left or right side. This process could be repeated for each subsequent layer until all the layered tread blocks have been created. It is possible that a different sequence could be used such as laying the first layer for all the tread blocks on the left side then laying the first layer for all the tread blocks on the right side, however the cut pattern of the barrettes would have to be changed. Certain sequences may increase the overall production time and the amount of waste material that needs to be recycled so an optimization of these factors is desirable. Once the tire intermediate has been completed, it can then be molded as previously described to create the desired final tire configuration that has a minimum amount of distortion of various tire components found underneath the tread.

By way of a further example, the topmost and bottommost right graphs describing the barrettes in FIG. 17 show how the barrettes can be laid. The drum may rotate in one direction, for approximately 30 degrees, until the first layer of a tread block has been laid one side of the midplane of the tire, such as the left side, and then rotated another 15 degrees before the first layer for the tread block on the right side is laid. As mentioned previously, this process is continued until a full rotation of the tire intermediate has been made and half the barrettes have had a layer laid down. Indexing is then made and the same pattern is executed until all a layer has been laid down for every desired barrette. This process can be used in instances where the angle at which the barrette is laid relative to the circumferential direction on the tire intermediate is the same as the angle at which it is originally cut or not. The reason this angle may be changed will now be discussed.

Another challenge faced by the inventors was how to make long lugs or barrettes in the axial direction for extra wide tires when the equipment could not create strips with the exact geometry because of the width limitations of the equipment. The solution for this problem is illustrated by the second graph from the left, the topmost right graph, and the bottommost right graph of FIG. 17. Strips inclined at a steeper angle with respect to the feed direction or circumferential direction of the tire are cut and as they are applied to the tire intermediate, the drum is translated while it is rotated, resulting in a pivoting movement of the strips so that they form angles less steep with respect to the circumferential direction of the tire and therefore are longer in the axial direction. While this is particularly useful for implementing the present invention on larger sized tires with undersized equipment, it is contemplated that this technique just described could also be used for situations where the equipment is capable of making the exact desired geometry but a narrow sheet of rubber is desired to be used in order to conserve waste material for example.

All the embodiments of the invention discussed thus far, are sometimes referred to by the inventors as being three dimensional (or 3D) because the tread blocks mimic the desired final cured geometry very closely, meaning that little to no extra rubber needs to be added to the green or uncured tread in order to accommodate the flow of rubber to create the final cured geometry. So, as much as 10% of the rubber volume can be saved from the flat green tread which was prone to create non-uniformities as tread features were molded into it by using the 3D solutions. However, using these 3D solutions could triple or even quadruple the cycle time necessary to make the tire. On the other hand, these 3D solutions can accommodate the use of different materials within the various layers of the tread features and/or tread base. As can be seen, tradeoffs exist between the amount of rubber saved, the increase in cycle time, the reduction of non-uniformities, and the types of materials that can be used in the tread features and/or tread base. In many applications, the highest contribution of cost to the tire is the cycle time and this need outweighs the other factors when needing to make the tire otherwise it cannot be sold for a suitable profit. Accordingly, the inventors proceeded to develop another solution that could provide some material savings and a cost effective production cycle time as well as the needed reduction in non-uniformities.

Consequently, the inventors devised what they sometimes refer to as a two or two and a half dimensional (or 2D or 2½D) solution using one or more scalloped layers. These scalloped or notched areas create variable sections or volumes of rubber circumferentially around the edges of tread according to a repeating pattern matching that of the mold shoulder features. This pre-positioning of the volume of rubber around the edges allows a reduction of 5-6% of the tread rubber otherwise needed to create the desired architecture using a flat green tread while only doubling the standard cycle time due to a slower posing speed as compared to that of a simple flat tread. These scalloped layers can be made using any of the techniques discussed previously but the process shown and described in FIG. 12 is particularly suitable for creating these layers for reasons that are readily apparent to those skilled in the art. Unlike previously described, the cut out portions would be recycled and the leftover sheet would be applied to the tire intermediate.

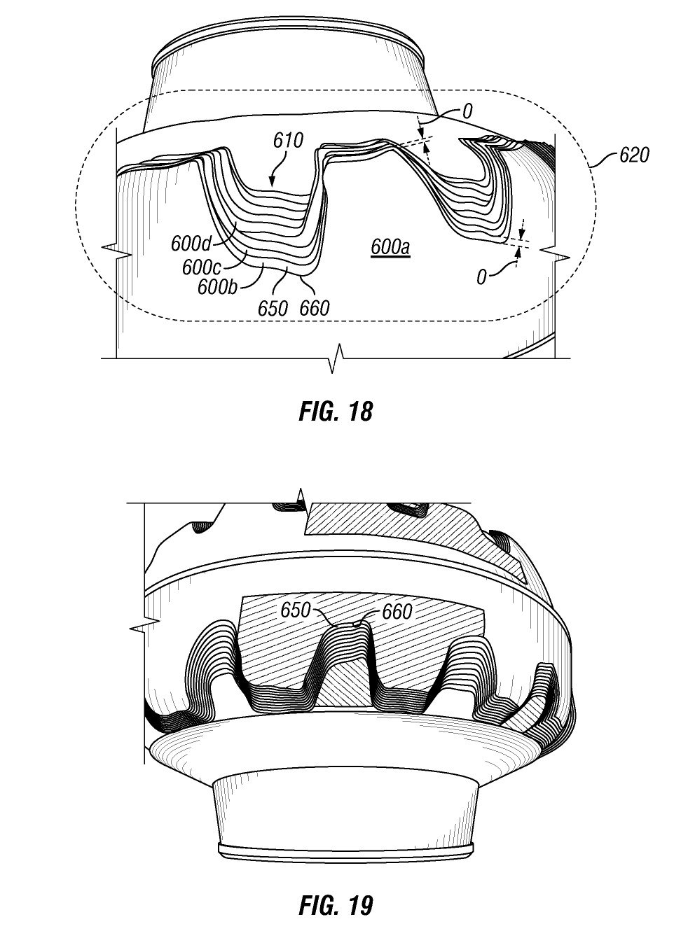

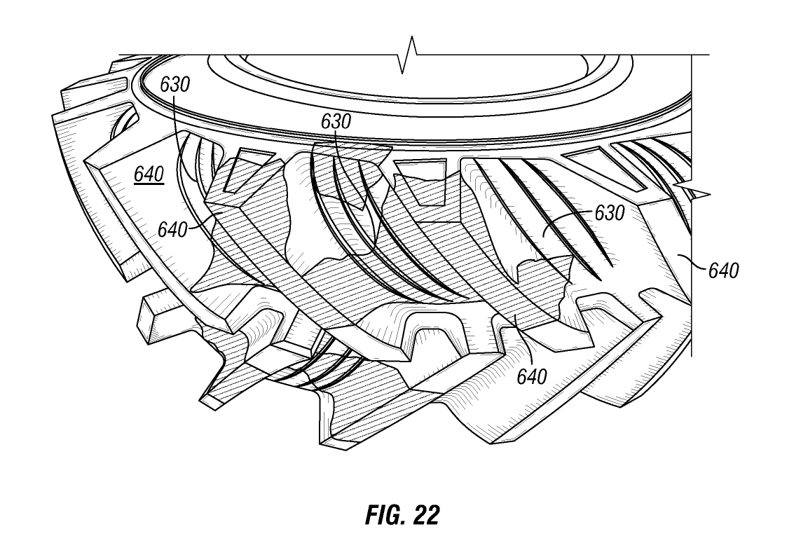

Turning now to FIGS. 18 thru 20, an example of this 2D technique is shown. Layers 600 of tread extend the full axial width of the tread and that have a series of scallops or notches 610 along the lateral or axial edges 620 of the layers are laid on top of the base rubber or inflated carcass. The scallops are aligned with the position of intended lateral grooves 630 and on either side of intended lugs or tread blocks 640 on each side of the midplane of the tire (see FIG. 21 which shows this spatial relationship before cure relative the desired final shape and location of a cured lug with only one lug being shown for clarity). Each layer has a ground face 650 and an edge face 660, similar to what has been described for the layers comprising the tread blocks for the 3D solutions. Likewise, there is an offset distance for the edge face of one layer to the edge face of the next stacked layer as previously described. In addition, the amount of the offset from the notch area 610 to the lug area 640 changes. Specifically, the amount of offset is less in the lug area than in the notch area due to the higher need for material to build up the lug near the shoulder as has been described above. The height of the scalloped layers is less than the height the desired height of the final cured lugs to allow for enough rubber flow.

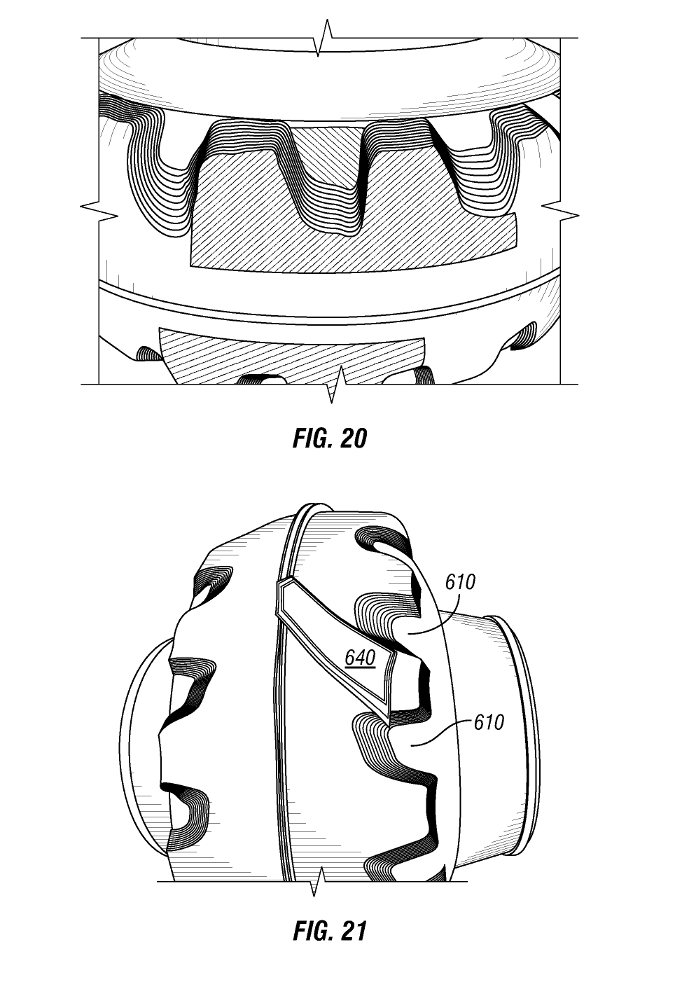

Note that FIGS. 19 and 20 show in cross-hatching the top surface of the topmost layer and the base layer located at the bottom of the notch in order to illustrate the movement of the rubber during molding. FIG. 22 shows the final geometry including the grooves 630 and tread blocks 640 as well as the final position of the rubber that was cross-hatched in FIGS. 19 and 20 by showing the final position of the rubber using the same type of cross-hatching. The area in the shoulders where the offset was greater between the edge faces of the layers has the most material flow exhibited.

It is further contemplated that the tradeoffs between the 2D and 3D solutions could be optimized by building tread blocks on top of the scalloped layers where appropriate to provide the needed rubber to ensure the final tread configuration will be successfully molded although this would likely increase the production cycle time. A tread block might be located in the shoulder areas only when the 2D solution is unable to provide sufficient rubber. In such a case, the added tread block may be a mini block such that it would not extend to the crown of the tire. Such tread blocks could have the same offset edge faces for their individual layers in any manner previously described or could consist of a single member or layer.

Also, materials having different properties may also be used within these tread blocks if so desired for any reason including those discussed above. Also, a single thick scalloped layer could be used if configured properly. For example, it would be ideal that the draft angle of the edge faces, which is the angle the edge faces make with the radial direction of the tire, in the notches were steeper than near the lug areas in order create a similar control of rubber flow that is provided by altering the offset of the edge faces from the notched area to the lug area when a plurality of scalloped layers are used. In some cases, when the equipment is undersized for the tire to be made, one or more layers with notches corresponding to one axial extent of the tread may be combined with one or more layers that have notches corresponding to another axial extent of the tread. There could also be one or more layers or windings found in between the notched layers for making an even wider tire. The locations of the scallops for any of the embodiments described herein may not be located at the axial or lateral extents of the tread but may be located closer to the midplane of tread as may be the case when other features are found near the shoulder of the tread such as ribs. Also, the configuration and dimensions associated with the scallops can vary from what has been illustrated in the FIGURES and may include other shapes and dimensions including the amount by which they extend in the circumferential and axial directions of the tire. As far as configuration, a saw-tooth profile has been contemplated by the inventors. In any event, these configurations and dimensions may be varied depending on the application of this technology.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed:

1-31. (canceled)

32. A tire intermediate defining axial, radial, and circumferential directions, the tire comprising:
a pair of sidewalls opposed to each other along the axial direction;
a tread portion extending between said pair of sidewalls, said tread portion having a base and having at least one layer having at least one lateral edge with scallops thereon, the scalloped layer being laid on said base of said tread portion and said scalloped layer further having
a configuration such that said scallops align with features of a mold that form the grooves of the cured tire.

33. A tire intermediate as in claim 32, wherein said scalloped layer of the tread defines an edge face surrounding a ground face wherein the angle which the edge face makes with the radial direction of the tire increases in the scalloped areas.

34. A tire intermediate as in claim 32, wherein said tire intermediate further comprises a plurality of layers with scallops on both their lateral edges, wherein each of the layers defines an edge face and a ground face.

35. A tire intermediate as in claim 34, wherein the edge face of each layer has a surface area that decreases between successive edge faces of the layers along the radially-outward direction.

36. A tire intermediate as in claim 34, wherein each of the layers with scallops has a thickness in the radial direction that is substantially the same between the layers.

37. A tire intermediate as in claim 32, wherein said scalloped layer extends along the entire axial width of the tread and both lateral edges of the layer have scallops.

38. A tire intermediate as in claim 34, wherein said tread portion further comprises an intersection between said ground face and said edge face of each layer, wherein the majority of said intersections of the layers are configured to contact the wall of a mold cavity substantially simultaneously as the mold closes.

39. A tire intermediate as in claim 38, wherein all the intersections between said ground faces and said edge faces are configured to contact the wall of the mold cavity substantially simultaneously as the mold closes.

40. A tire intermediate as in claim 34, wherein lugs are formed between the scalloped areas during molding of the tire intermediate.

41. A tire intermediate as in claim 34, wherein said tread portion further comprises an offset distance between the edge faces of the stacked layers in a direction perpendicular to said edge faces and wherein said offset distance between the edge faces is greater in the scalloped areas than in other areas.

42. A method of manufacturing a tread portion for a tire, the tread portion having tread blocks after the tread portion is cured, the method comprising the steps of:
providing a base of tread rubber;
supplying a sheet of tread rubber for constructing at least one layer;
cutting the sheet of tread rubber with scalloped portions on one of its lateral or axial edges, each scalloped portion forming a groove when the tread is cured; and
placing at least one layer on the base at a predetermined location.

43. A method of manufacturing a tread portion for a tire as in claim 42, wherein said step of cutting further comprises cutting a plurality of scalloped layers having different sizes that have scalloped portions on both lateral edges and further comprising the step of stacking said scalloped layers onto one or more layers of the placing step.

44. A method of manufacturing a tread portion for a tire as in claim 43, wherein said step of stacking further comprises stacking successively smaller layers on top of each other.

45. A method of manufacturing a tread portion for a tire as in claim 43, wherein said step of stacking is continued until said tread reaches a predetermined number of layers.

46. A method of manufacturing a tread portion for a tire as in claim 43, wherein said step of cutting comprises directing a stream of water at high pressure towards the sheet of tread rubber.

47. A method of manufacturing a tread portion for a tire as in claim 43, the method further comprising the steps of feeding the base with the scalloped layers to an untreaded tire intermediate for wrapping around the untreaded tire intermediate.

48. A method of manufacturing a tread portion for a tire as in claim 43, wherein said step of cutting comprises the use of cutting blades.

49. A method of manufacturing a tread portion for a tire as in claim 48, wherein said cutting blades are attached to a wheel that is positioned proximate the sheet of tread rubber.

50. A method of manufacturing a tread portion for a tire as in claim 45, wherein the successively smaller layers have edge faces that define the perimeter of the layers and the tread block, wherein the distance between the edge faces in a direction that is perpendicular thereto varies along the perimeter of the edges of the scalloped layers.

51. A method of manufacturing a tread portion for a tire as in claim 50, wherein the distance between edge faces is less in the area where the bulk of the material is needed to form a tread block and is more in the area where less material is needed to form the tread block such as a groove.
